(19) United States
(12) Patent Application Publication
(10) Pub. No.: US 2011/0135142 A1
(43) Pub. Date: Jun. 9, 2011

(54) MAGNETIC CIRCUIT AND SPEAKER USING SAME

(76) Inventors: Tao Shen, Shenzhen (CN); Chun-Hui Shi, Shenzhen (CN)

(21) Appl. No.: 12/858,072

(22) Filed: Aug. 17, 2010

(30) Foreign Application Priority Data
Dec. 7, 2009 (CN) 200920261215.3

(51) Int. Cl. H04R 9/06

(52) U.S. Cl. 381/414

(57) ABSTRACT

Disclosed is a magnetic circuit for a speaker. The magnetic circuit includes a yoke defining a bottom and a sidewall extending perpendicularly from the bottom, a magnet mounted on the bottom of the yoke, a pole plate mounted on a top of the magnet. The magnet includes a wider portion mounted on the bottom of the yoke and a narrower portion carrying the pole plate.

### BACKGROUND OF THE INVENTION

1. Field of the Invention

The present invention generally relates to the art of electromagnetic transducers and, more particularly, to a magnetic circuit of a speaker.

2. Description of Related Art

Micro speakers are widely applied in mobile devices, such as mobile phones, for converting electrical signals to audible sounds. Generally, a speaker has a magnetic circuit including a yoke, a magnet positioned in the yoke, a pole plate mounted on the magnet, and a voice coil. A magnetic gap is formed between an inner surface and an outer surface of the magnet for partially receiving the voice coil. The magnet is generally cylindrical and has an even diameter from the top to the bottom. The yoke must be made of magnetic materials. As the magnetic conduction of the sidewall of the yoke, the magnetic field close to the bottom of the yoke produces harmful components, which reduces the magnetic flux through the voice coil, and further affects the sensitivity of the speaker.

The present invention is provided to solve the problem.

### SUMMARY OF THE INVENTION

In one embodiment of the invention, a magnetic circuit for a includes a yoke defining a bottom and a sidewall extending perpendicularly from the bottom, a magnet mounted on the bottom of the yoke, a pole plate mounted on a top of the magnet, and a magnetic gap formed between an outer surface of the magnet and an inner surface of the sidewall of the yoke. The magnet includes a wider portion mounted on the bottom of the yoke and a narrower portion carrying the pole plate.

In an alternative embodiment of the invention, a magnetic circuit includes a yoke defining a bottom and a sidewall extending perpendicularly from the bottom, a magnet mounted on the bottom of the yoke, the magnet including a first part and a second part, and a pole plate mounted on a top of the magnet. A distance from an outer surface of the first part of the magnet to an inner surface of the sidewall is greater than that from an outer surface of the second part of the magnet to the inner surface of the sidewall.

Other features of the present invention will become more apparent to those skilled in the art upon examination of the following drawings and detailed description of exemplary embodiments.

### BRIEF DESCRIPTION OF THE DRAWINGS

FIG. 1 is a cross-sectional view of a magnetic circuit of a speaker in accordance with a first embodiment of the present invention.

FIG. 2 a cross-sectional view of a magnetic circuit of a speaker in accordance with a second embodiment of the present invention.

### DETAILED DESCRIPTION OF THE PREFERRED EMBODIMENT

Reference will now be made to describe the exemplary embodiments of the present invention in detail.

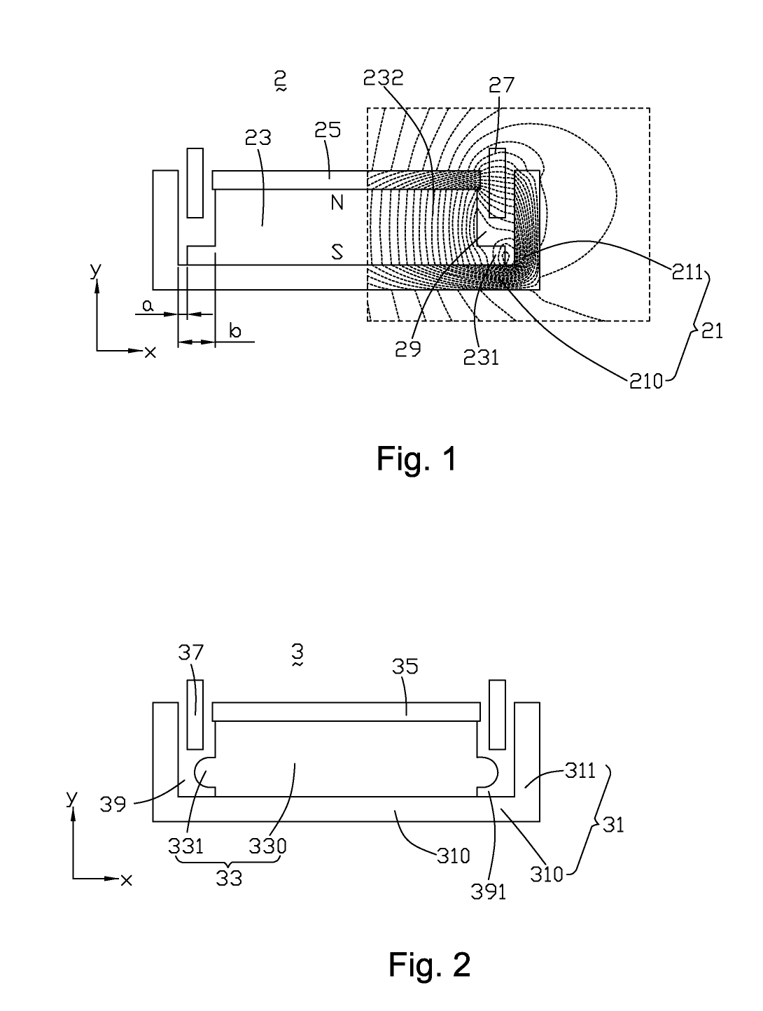

FIG. 1 illustrates a magnetic circuit 2 used in a speaker. The magnetic circuit 2 includes a yoke 21, a magnet 23, a pole plate 25, and a voice coil 27.

The yoke 21 is configured to be like a bowl and defines a receiving space for accommodating the magnet 23 and the pole plate 25. As shown in FIG. 1, the yoke 21 defines a bottom 210 parallel to the direction X and a sidewall 211 parallel to the direction Y. The direction X is perpendicular to the direction Y. The magnet 23 is positioned on the bottom 210 of the yoke 21, and the pole plate 25 is attached to a top surface of the magnet 23. A magnetic gap 29 is formed between an outer surface of the magnet 23 and the sidewall 211 of the yoke 21. The voice coil 27 is partially received in the magnetic gap 29.

Typically, a speaker includes a magnetic circuit as mentioned above, and further includes a diaphragm assembled with the voice coil. While the voice coil is electrified, the voice coil will be activated to move due to Lorentz force along the direction Y. The movement of the voice coil drives the diaphragm to move synchronously. As direction and intensity of the current passing through the voice coil is varied, the movement of the diaphragm is upward or downward, alternatively, which is called vibration. The vibration converts the electrical signals to audible sound waves.

The magnet 23 includes a wider portion 231 mounted on the bottom 210 of the yoke 21 and a narrower portion 232 extending from the wider portion 231. The pole plate 25 is positioned on the top of the narrower portion 232. One end of the voice coil 27 is received between the outer surface of the narrower portion 232 and the sidewall 211 of the yoke 21. At the same time, the voice coil 27 is located above the wider portion 231. A distance from the outer surface of the narrower portion 232 to the sidewall 211 is defined as Width b, and a distance from the outer surface of the wider portion 231 to the sidewall 211 is defined as Width a. Width b is greater than Width a. Thus the magnetic gap 29 is divided into two parts, one having the Width a, and another having the Width b.

As an exemplary embodiment, the magnet 23 has a south magnetic pole S close to the bottom 210 of the yoke 21 and a north magnetic pole N close to the pole plate 25. The magnetic field lines always form a closed curve starting from the north magnetic pole N and ending at the south magnetic pole S. Magnetic field lines produced by the wider portion 231 of the magnet 23 repel the magnetic field lines produced by the narrower portion 232. Thus, more magnetic field lines are deflected toward the voice coil 27. Another word, the harmful component is reduced, and the effective component is increased. As a result, the magnetic flux through the voice coil 27 is increased, which improves the sensitivity of the speaker.

FIG. 2 illustrates a magnetic circuit 3 of a speaker in accordance with a second embodiment of the present invention.

The magnetic circuit 3 includes a yoke 31, a magnet 33, a pole plate 35, and a voice coil 37.

The yoke 31 is configured to be like a bowl and defines a receiving space for accommodating the magnet 33 and the pole plate 35. As shown in FIG. 2, the yoke 31 defines a bottom 310 parallel to the direction X and a sidewall 311 parallel to the direction Y. The direction X is perpendicular to the direction Y. The magnet 33 is positioned on the bottom 310 of the yoke 31, and the pole plate 35 is attached to a top surface of the magnet 33. A magnetic gap 39 is formed between an outer surface of the magnet 33 and the sidewall 311 of the yoke 31. The voice coil 37 is partially received in the magnetic gap 39.

The magnet 33 includes a main body 330 and a projecting portion 331 extending from an outer surface of the main body 330 toward the sidewall 311 of the yoke 31. The main body 330 is mounted on the bottom 310 of the yoke 31 and the projecting portion 331 is located below the voice coil 37. An interstice 391 is formed between the projecting portion 331 and the bottom 310 of the yoke 31.

The magnetic field lines always form a closed curve starting from the north magnetic pole N and ending at the south magnetic pole S. Magnetic field lines produced by the main body 330 of the magnet 33 repel the magnetic field lines produced by the projecting portion 331. Thus, more magnetic field lines are deflected toward the voice coil 37. Another word, the harmful component is reduced, and the effective component is increased. As a result, the magnetic flux through the voice coil 37 is increased, which improves the sensitivity of the speaker.

While the present invention has been described with reference to the specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. A magnetic circuit for a speaker, comprising:
a yoke defining a bottom and a sidewall extending perpendicularly from the bottom;
a magnet mounted on the bottom of the yoke;
a pole plate mounted on a top of the magnet;
a magnetic gap formed between an outer surface of the magnet and an inner surface of the sidewall of the yoke; wherein
the magnet includes a wider portion mounted on the bottom of the yoke and a narrower portion carrying the pole plate.

2. A magnetic circuit for a speaker, comprising:
a yoke defining a bottom and a sidewall extending perpendicularly from the bottom;
a magnet mounted on the bottom of the yoke, the magnet including a first part and a second part;
a pole plate mounted on a top of the magnet; wherein
a distance from an outer surface of the first part of the magnet to an inner surface of the sidewall is greater than that from an outer surface of the second part of the magnet to the inner surface of the sidewall.

3. A speaker, comprising:
a yoke;
a magnet mounted on the yoke;
a pole plate mounted on a top of the magnet;
a magnetic gap formed by the magnet and the yoke;
a voice coil partially located in the magnetic gap; wherein
the magnet defines a main body mounted on the yoke and a projecting portion protruding from an outer surface of the main body into the magnetic gap.

4. The speaker as described in claim 3, wherein the voice coil is located above the projecting portion.

5. The speaker as described in claim 3, wherein the projecting portion departs from the bottom of the yoke for forming an interstice.
